(19) United States
(12) Patent Application Publication
(10) Pub. No.: US 2019/0302530 A1
(43) Pub. Date: Oct. 3, 2019

(54) RECYCLING BACKLIGHT

(71) Applicant: 3M INNOVATIVE PROPERTIES COMPANY, St. Paul, MN (US)

(72) Inventors: Nathaniel K. Naismith, Woodbury, MN (US); Stephen J. Etzkorn, Woodbury, MN (US)

(21) Appl. No.: 16/308,169

(22) PCT Filed: Jun. 5, 2017
(86) PCT No.: PCT/US2017/035990

§ 371 Date: Dec. 7, 2018

Related U.S. Application Data
(60) Provisional application No. 62/348,238, filed on Jun. 10, 2016.

(51) Int. Cl. G02F 1/1335

(52) U.S. Cl. CPC G02F 1/133603; G02F 1/133536; G02F 2001/133541; G02F 1/133606; G02F 1/133605

(57) ABSTRACT

Recycling backlight systems are described. In particular, recycling backlight systems including a circular reflective polarizer, a reflector with a metalized reflective surface, and a lightguide disposed between the reflector and the circular reflective polarizer are described. The described backlights can increase recycling backlight efficiency.

### BACKGROUND

Backlights provide substantially uniform illumination for a light-gating type display, such as a liquid crystal display. Displays such as liquid crystal displays that rely on polarization manipulation to form images may use efficient light recycling cavities in order to convert light of an unusable polarization (e.g. light that would be otherwise absorbed by the liquid crystal module) into light of a usable polarization.

### SUMMARY

In one aspect, the present description relates to a recycling backlight system. The backlight system includes a circular reflective polarizer, a reflector having a metallized reflective surface, the metallized reflective surface facing the circular reflective polarizer, and a lightguide disposed between the reflector and the circular reflective polarizer.

In another aspect, the present description relates to a recycling backlight system. The backlight system includes a linear reflective polarizer, a reflector having a metallized reflective surface, the metallized reflective surface facing the linear reflective polarizer, a lightguide disposed between the reflector and the linear reflective polarizer, a lightguide disposed between the reflector and the linear reflective polarizer, and a quarter wave retarder disposed between the reflector and the lightguide.

### BRIEF DESCRIPTION OF THE DRAWINGS

FIG. 1 is an exploded front elevation view of an exemplary recycling backlight system.

FIG. 2 is an exploded front elevation view of another exemplary recycling backlight system.

FIG. 3 is an exploded front elevation view of a recycling backlight system of either FIG. 1 or FIG. 2 with a liquid crystal module.

### DETAILED DESCRIPTION

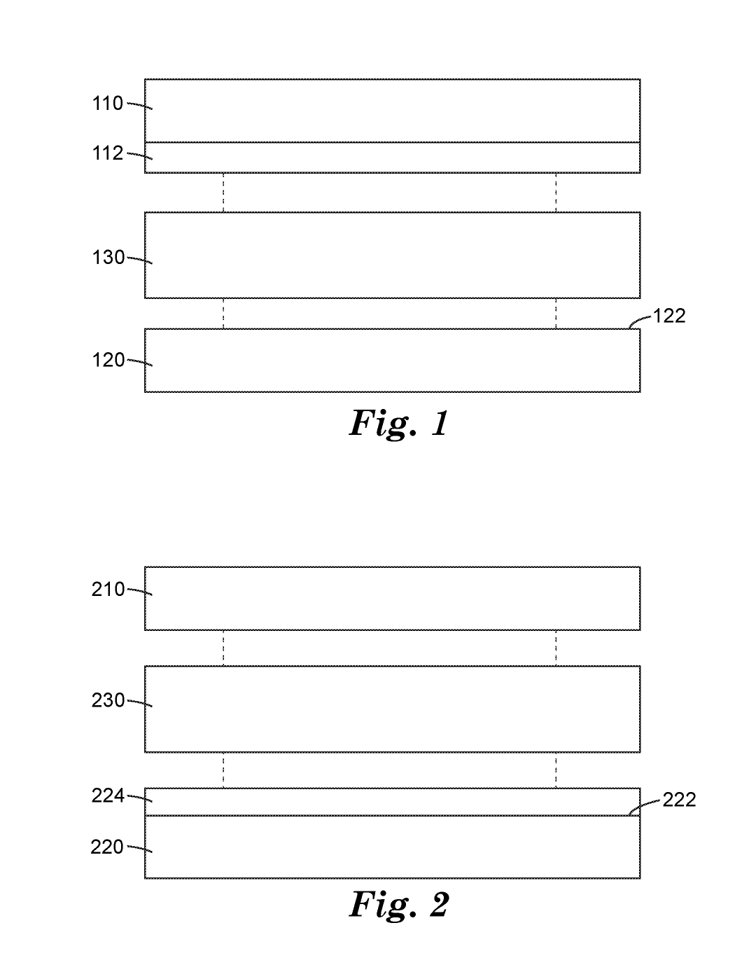

FIG. 1 is an exploded front elevation view of an exemplary recycling backlight system. The recycling backlight system includes linear reflective polarizer 110, quarter wave retarder 112, reflector 120 including metallized reflective surface 122, and lightguide 130.

Linear reflective polarizer 110 may be any suitable reflective polarizer, including a wire grid reflective polarizer or a multilayer optical film reflective polarizer. For example, linear reflective polarizer 110 may be or include a reflective polarizer laminate such as a DBEF reflective polarizer (available from 3M Company, St. Paul, Minn.). In some embodiments, the linear reflective polarizer may be an on-glass type reflective polarizer such as an APF reflective polarizer (available from 3M Company, St. Paul, Minn.)

Multilayer optical film reflective polarizers can be formed by any suitable combination of alternating birefringent materials, especially polymeric materials. In some embodiments, only one of the alternating layers may be birefringent. When oriented under carefully controlled process and material conditions, the layers form stacks of alternating high and low indexes of refraction along at least one of the orthogonal x, y, and z directions, where the x direction is the in-plane direction of greatest stretch. Reflective polarizers commonly have a closely matched (less than 0.05) index of refraction difference between the layers in one in-plane direction and a mismatched (greater than 0.05) index of refraction difference between the layers in the other in-plane direction. The optical thickness (index of refraction times the physical thickness) of each layer pair determines the center of the reflection band corresponding to that layer pair, and the index of refraction contrast (difference) between the two layers determines the relative strength of that reflection band. Various other details such as layer profile design, protective boundary layers, skin layers, or f-ratio of layer pairs may be modified as suitable for the desired application. The reflective polarizer may also have a dimensionally thick or stable layer to preserve or enhance physical characteristics such as warp resistance or stiffness.

Quarter wave retarder 112 or quarter wave plate is any suitable birefringent substrate that acts to retard light as to change its polarization from, for example, linearly to circularly polarized. In some embodiments, quarter wave retarder 112 may be a liquid crystal layer. In some embodiments, quarter wave retarder 112 may be a stretched polymeric film. In some embodiments, quarter wave retarder 112 may be a quarter wave retarder for 550 nm light, but may be a near-quarter wave retarder for other wavelengths of visible light. For example, linearly polarized light at 550 nm may be converted to circularly polarized light, but light at 400 nm or 700 nm may be converted into elliptically polarizer light. In some embodiments, quarter wave retarder may be understood to be a quarter wave retarder for at least one wavelength within the visible range. In some embodiments, the quarter wave retarder is achromatic, or at least substantially achromatic, meaning its retardance does not vary substantially with wavelength. In some embodiments, not varying substantially may mean that it does not vary more than 20%, more than 10%, or even more than 5%. In some embodiments, the quarter wave retarder may be configured to compensate for wavelength dispersion.

Together, the linear reflective polarizer and the quarter wave retarder in effect form a circular reflective polarizer. In other words, the linear reflective polarizer and the quarter wave retarder taken together reflects light of one circular polarization handedness and passes light the opposite circular polarization handedness (though it is passed as linearly polarized light). In some embodiments, the quarter wave retarder and the linear reflective polarizer need not be placed directly adjacent to one another. A circular mode reflective polarizer may be used to replace the linear reflective polarizer/quarter wave retarder combination, for example, a cholesteric reflective polarizer.

Reflector 120 can be any suitable reflector. In some embodiments, reflector 120 is a metal deposited mirror. In some embodiments, reflector 120 is a solid reflective metal. In some embodiments, reflector 120 is a multilayer optical film, such as ESR reflector (available from 3M Company, St. Paul, Minn.). In some embodiments, reflector 120 is a structured reflector. In some embodiments, reflector 120 is a structured reflector configured to redirect at least some of the light incident on it. In some embodiments, reflector 120 is a polymeric or other substrate with a metallized surface. In some embodiments, the structure of the reflector is or acts as a quarter wave retarder within the recycling backlight system. As shown in FIG. 1, metallized surface 122, if used, is on the side of the reflector facing the circular reflective polarizer. Note that this is only necessary if the rest of the reflector body is not transparent. If the reflector body is transparent, a metallized surface on the opposite side of the reflector from the circular polarizer may still be considered to be facing the circular reflective polarizer. In other words, it is necessary that the metallized reflective surface be in optical communication with the rest of the recycling backlight system.

Lightguide 130 may be any suitable thickness and may have any suitable shape. In some embodiments, lightguide 130 may be substantially planar or film-shaped. In some embodiments, lightguide 130 may be wedge shaped. In some embodiments, lightguide 130 is formed from a transparent polymeric material through injection molding or any other suitable process. Lightguide 130 may include any number of extraction features, for example, either positive or negative microfeatures. In some embodiments, the extraction features may be printed or screen printed dots or other scattering features. In some embodiments, in order to provide more uniform light extraction by area, the extraction features may be arranged in a particular pattern or gradient.

Light that is extracted from lightguide 130 is unpolarized so generally includes a mix of all polarization states. Light is either directly incident on circular reflective polarizer (quarter wave retarder and linear reflective polarizer, in some embodiments) or is reflected by reflector 120 and in next incident on the circular reflective polarizer. The linear reflective polarizer has a pass axis that substantially transmits light of a first polarization state and a block axis that substantially reflects light of an orthogonal polarization state. Left circularly polarized light is converted to a first linear polarization state, which, for purposes of explanation, can be assumed to be the polarization state passed by the reflective polarizer (the configurations of the pass and block axes and which handedness of circularly polarized light they correspond to will depend on the axial positioning of the reflective polarizer within the recycling backlight system. Right circularly polarized light, in this exemplary configuration, is converted to the linear polarization state reflected by the linear reflected polarizer and converted back to right circularly polarized light (its second pass through the quarter wave plate) and reflected back toward the reflector. Because of the metallized reflective surface of the reflector, circularly polarized light upon reflection changes its handedness. Therefore, the right circularly polarized light becomes left circularly polarized light, and is now converted to the pass polarization state for the reflective polarizer.

This handedness switching in a recycling backlight system allows for much higher brightness values given equivalent input brightness versus typical recycling systems. Typical recycling systems use reflection to re-randomize the polarization state of recycled light and may require a large number of bounces within the recycling backlight system before being transmitted. Each bounce increases a cumulative probability that a given light ray will be absorbed. Relying on the handedness shifting of the metalized reflective surface and combined with the reflective polarizer selecting based on the handedness of circularly polarized light enables a more efficient recycling system than these typical systems.

In order for the advantages associated with the circular reflective polarizer and the metalized reflective surface to be realized, it may be necessary to limit scattering and retardance in the cavity between the metalized reflective surface and the quarter wave plate. In some embodiments, the retardance for 550 nm light for a shortest path between the metalized reflective surface and the quarter wave plate is no more than 68 nm. In some embodiments, there is no scattering elements between the quarter wave plate and the metalized reflective surface that depolarize more than 30% of the light.

In some embodiments, all the components of the recycling backlight system are bonded to form a unitary body. In some embodiments, the components of the recycling backlight system are bonding with an adhesive, such a pressure sensitive adhesive, an optically clear adhesive, a UV curable adhesive, a heat curable adhesive, or the like. In some embodiments, the components of the recycling backlight system are heat bonded. In some embodiments, the components of the recycling backlight system are ultrasonically welded. In some embodiments, at least two different bonding methods or materials are used to bond the components of the recycling backlight system.

FIG. 2 is an exploded front elevation view of another exemplary recycling backlight system. The recycling backlight system includes linear reflective polarizer 210, reflector 220 including metallized reflective surface 222, quarter wave retarder 224, and lightguide 230. In the configuration of FIG. 2, quarter wave retarder 224 is not disposed on linear reflective polarizer 210 but rather on reflector 220. As in the recycling backlight system of FIG. 1, the quarter wave retarder need not be directly adjacent or attached to the reflector.

The configuration of FIG. 2 demonstrates the effective functionality of a circular reflective polarizer is preserved even when the quarter wave retarder is not disposed directly on the linear reflective polarizer. Even though lightguide 230 is disposed between quarter wave retarder 224 and linear reflective polarizer 210, the combination of the linear reflective polarizer and the quarter wave plate functions as a circular reflective polarizer. The path between the quarter wave retarder and the linear reflective polarizer may have controlled limits on depolarizing scattering and retardance as described in conjunction with FIG. 1, except for the configuration of FIG. 2, the optical path of interest is between quarter wave retarder 224 and linear reflective polarizer 210. Also as in FIG. 1, metalized reflective surface 222 need not be on the side of reflector 220 adjacent to the quarter wave retarder, as long as the reflector 220 is substantially transparent and metalized reflective surface 222 is in optical communication with quarter wave retarder 224. In the case where the quarter wave plate is not disposed adjacent to the metalized reflective surface, the limits on retardance and depolarizing scattering should be applied to optical paths between the quarter wave plate and the metalized reflective surface as well.

Similarly to FIG. 1, in some embodiments, all the components of the recycling backlight system are bonded to form a unitary body. In some embodiments, the components of the recycling backlight system are bonding with an adhesive, such a pressure sensitive adhesive, an optically clear adhesive, a UV curable adhesive, a heat curable adhesive, or the like. In some embodiments, the components of the recycling backlight system are heat bonded. In some embodiments, the components of the recycling backlight system are ultrasonically welded. In some embodiments, at least two different bonding methods or materials are used between components of the recycling backlight system.

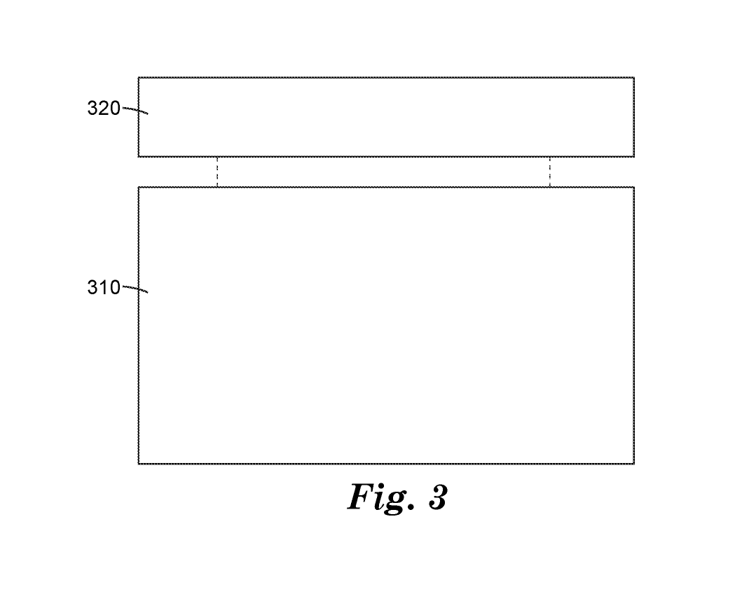

FIG. 3 is an exploded front elevation view of a recycling backlight system of either FIG. 1 or FIG. 2 with a liquid crystal module. Recycling backlight system 310 is combined with liquid crystal module 320. Recycling backlight system 310 corresponds to either the recycling backlight system in FIG. 1 or the recycling backlight system in FIG. 2. FIG. 3 illustrates that the recycling backlight system can be used with a liquid crystal module. In some embodiments, the liquid crystal module includes a liquid crystal layer and two absorbing polarizers. The absorbing polarizers may be crossed or parallel, depending on the type of liquid crystal material used. In some embodiments, the recycling backlight may be laminated or adhered to liquid crystal module 320. In some embodiments, the entire recycling backlight and liquid crystal module combination may be bonded to form a unitary structure, either through adhesives, heat bonding, ultrasonic welding, or some combination thereof.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

### Preparation of Light Guide Stack

A light guide stack for a recycling backlight system was assembled as follows. The bottom layer was a linear prismatic film with a pitch of 17 micrometers made from a UV-curable acrylate resin on a 2 mil (51 micrometer) thick PET substrate. The prisms were made using the well-known cast-and-cure process. The prisms had a vertex angle of 90 degrees and base angles of 39 and 51 degrees. Using a standard bench-top method the surface of the prisms was sputter coated with a 3 nm AZO (aluminum doped zinc oxide), then a 150 nm silver layer, and then a 75 nm AlSiOx layer. The coated film was then laminated to a 50 micrometer thick silicone pressure sensitive adhesive with refractive index 1.417, leaving a release liner on the open adhesive side. The laminate was then cut to a size of 195.0 mm by 288.4 mm with the prisms running in the long direction.

A light guide plate was compression injection molded using LC1202 polycarbonate (available from Idemitsu Kosan Co., Tokyo, Japan) with refractive index of 1.585. It was 550 micrometers thick, 196.75 mm long and 289.5 mm wide, with the light input edge along one of the long sides. The top side of the light guide had prisms facing outwards and running down-guide (along the short direction) with a pitch of 17 micrometers and an average included angle of 156.8 degrees and equal base angles of 11.6 degrees. The prism features extended continuously down-guide, starting at the input edge and terminating 1.7 mm from the distal edge. There was a planar featureless area 0.5 mm wide on the right side of the light guide and 0.1 mm wide on the left side of the light guide. The bottom side of the light guide plate had prisms as extraction features oriented cross-guide (along the long direction) and cut into the light guide with an average depth of 1.29 micrometers, a base angle of 3.2 degrees facing the light input side of the light guide and with the other base angle 20 degrees. The extraction feature pattern area extended from the input end to the distal end, and there was a an average gap of 0.9 mm on the left side of the light guide and 0.2 mm on the right side of the light guide. The extraction features were segmented cross-guide and had a density that increased from the light input side to the distal side. The extractor density d at a down guide position x was approximately given by the equation below.

d=7×10⁻⁶x²+0.0008x+0.0234

The sputter-coated prism film was then laminated to the bottom side of the light guide plate after removal of the release liner. The lamination was done do that the 39 degree facet of the prisms faced the light input edge of the light guide. The lamination left a 0.55 mm gap on the short edges of the light guide, a 1 mm gap on the input edge, and a 0.75 mm gap on the distal end. Next a cladding for the top side of the light guide was prepared by laminating a cast 250 micrometer thick polycarbonate film with refractive index 1.585 to a 50 micrometer thick silicone pressure sensitive adhesive having a refractive index of 1.417, leaving a release liner on the open adhesive side. The laminated films were then cut to dimensions of 195.0 mm by 288.4 mm, the release liner was removed, and the cladding was adhered to the upper layer of the light guide plate.

### Preparation of Additional Films

Other separate films were prepared to use in testing. A Sanritz HLC2-5618S absorbing polarizer (available from Sanritz America, Chula Vista Calif.) was laminated using its own adhesive to 3M APF-V3 (available from 3M Company, St. Paul Minn.) with the transmission axis of the reflective polarizer aligned with the transmission axis of the absorbing polarizer. The laminated film was then cut to dimensions of 195.0 by 288.4 with the transmission axis along the long direction.

A second Sanritz polarizer was laminated to APF-QWP (available from 3M Company) with the transmission axes of the films again aligned. The laminated film was then cut in the same way to the same dimensions as above.

Two PET samples were also prepared. One, Biax PET, was a 2 mil (51 micrometer) thick PET manufactured using a biaxial orientation process. The second (TDO PET), of the same thickness, was manufactured using a transverse direction orientation, stretched primarily in a direction perpendicular to the web-path. Measurements of these films were made using samples from various cross-web locations on the film to determine a range of retardances and retardance orientations. Retardance measurements were made with an AxoScan Mueller Matrix Polarimeter (available from Axometrics Inc., Huntsville Ala.). Table 1 records retardance and retardance orientation for the various components that are included in the testing described below.

### Testing

The light guide stack as described was illuminated from the light input side of the light guide using NSSW306F-HG LEDs (available from Nichia Corp., Tokushima, Japan) on a flexible printed circuit with a spacing of 4.825 mm and with the LEDs powered at 20 milliamps per LED. Measurements were made of the area average luminance and the luminance relative to the combination of the light guide stack with the laminated polarizer combination (Sanritz absorbing polarizer/APF-V3) and with the APF-V3 facing the light guide stack and separated form it by a small air gap. A Radiant Imaging Prometric I-Plus IC-PM18 system (available from Pro-Lite Technology Ltd., Bedfordshire UK) with 200 mm Canano lens EF 1:2.8 at a 3.8 meter working distance was used to measure luminance. Results are reported in Table 2 for each configuration that was tested. The first configuration in Table 2 refers to a measurement of the basic light guide stack with no additional films. Where additional films or film combinations are named, they were offset from the basic light guide stack by a small air gap. Where a Sanritz absorbing polarizer/APF-QWP combination was used, the APF-QWP faced the light guide stack.

TABLE 1

| | | Total | Linear | Retardance |
|---|---|---|---|---|
| | Position on | Retardance @ | Retardance @ | Orientation |
| Layer | Sample | 550 nm (nm) | 550 nm (nm) | (degrees) |
| LGP + | Right | 41.950657 | 40.996657 | 62.991981 |
| PC Film | | | | |
| LGP + | Left | 6.600405 | 6.506924 | 29.385715 |
| PC Film | | | | |
| LGP + | Center | 15.969 | 15.818142 | 66.902012 |
| PC Film | | | | |
| LGP | Right Edge | 62.718651 | 62.716364 | −87.45458 |
| LGP | Left Edge | 52.58046 | 52.579213 | 75.84756 |
| LGP | Center | 49.850735 | 49.849227 | 88.365564 |
| PC Film | Right | 49.736984 | 49.725112 | 33.99106 |
| PC Film | Left | 43.43594 | 43.434524 | −1.63145 |
| PC Film | Center | 39.195087 | 39.18963 | 6.292234 |
| TDO PET | Center | 5764.893066 | 5764.882748 | −5.294661 |
| Biax PET | Center | 2306.410156 | 2306.236051 | −15.149148 |
| Silicone | Sample 1 | 0.340591 | 0.05563 | −11.138869 |
| Adhesive | | | | |
| Silicone | Sample 2 | 0.313928 | 0.07912 | −9.952809 |
| Adhesive | | | | |

TABLE 2

| | Luminance | Relative |
|---|---|---|
| Sample (listed in order from bottom to top) | (cd/m²) | Luminance |
| Light guide stack only | 4,995.03 | 250% |
| Light guide stack + Polarizer + 3M APF-V3 | 2,001.73 | 100% |
| Light guide stack + 3M APF-V3 + Polarizer | 2,056.39 | 103% |
| Light guide stack + 3M APF-QWP + | 2,557.04 | 128% |
| Polarizer | | |
| Light guide stack + TDO PET 0 Degree | 1,905.82 | 95% |
| Orientation + 3M APF-V3 + Polarizer | | |
| Light guide stack + TDO PET 90 Degree | 1,893.04 | 95% |
| Orientation + 3M APF-V3 + Polarizer | | |
| Light guide stack + 3M APF-V3 + Polarizer | 2,024.84 | 101% |
| (mid-test series replicate) | | |
| Light guide stack + Biax PET 0 Degree | 2,048.89 | 102% |
| Orientation + 3M APF-V3 + Polarizer | | |
| Light guide stack + Biax PET90 Degree | 2,044.33 | 102% |
| Orientation + 3M APF-V3 + Polarizer | | |
| Light guide stack + Biax PET 45 Degree | 2,046.82 | 102% |
| Orientation + 3M APF-V3 + Polarizer | | |

The following are exemplary embodiment according to the present disclosure:

Item 1. A recycling backlight system, comprising:
a circular reflective polarizer;
a reflector having a metallized reflective surface, the metallized reflective surface facing the circular reflective polarizer; and
a lightguide disposed between the reflector and the circular reflective polarizer.
   Item 2. The recycling backlight system of item 1, wherein the circular reflective polarizer includes a linear reflective polarizer and a quarter wave retarder, wherein the quarter wave retarder is disposed nearer to the lightguide.
   Item 3. The recycling backlight system of item 1, further comprising a liquid crystal module, wherein the liquid crystal module is disposed nearest the circular reflective polarizer.
   Item 4. The recycling backlight system of item 1, wherein the reflector, the circular reflective polarizer, and the lightguide are bonded together to form a unitary body.
   Item 5. The recycling backlight system of item 4, wherein the reflector, the circular reflective polarizer, and the lightguide are heat bonded.
   Item 6. The recycling backlight system of item 4, wherein the reflector, the circular reflective polarizer, and the lightguide are adhered with pressure sensitive adhesive.
   Item 7. The recycling backlight system of item 4, wherein the reflector, the circular reflective polarizer, and the lightguide are adhered with optically clear adhesive.
   Item 8. The recycling backlight system of item 4, wherein the reflector, the circular reflective polarizer, and the lightguide are bonded by at least two different methods.
   Item 9. The recycling backlight system of item 1, wherein the reflector is a structured reflector.
   Item 10. The recycling backlight system of item 8, wherein the structured reflector is configured to redirect at least a portion of light incident on the structured reflector.
   Item 11. The recycling backlight system of item 1, wherein the reflector is a specular reflector.
   Item 12. The recycling backlight system of item 1, wherein between the circular reflective polarizer and the reflector, there is no layer having a retardance of more than 68 nm.
   Item 13. The recycling backlight system of item 1, wherein between the circular reflective polarizer and the reflector, the total retardance for 550 nm light traveling a shortest path between the circular reflective polarizer and the reflector is no more than 68 nm.
   Item 14. A recycling backlight system, comprising:
a linear reflective polarizer;
a reflector having a metallized reflective surface, the metallized reflective surface facing the linear reflective polarizer;
a lightguide disposed between the reflector and the linear reflective polarizer; and
a quarter wave retarder disposed between the metallized reflective surface and the lightguide.
   Item 15. The recycling backlight system of item 14 further comprising a liquid crystal module, wherein the liquid crystal module is disposed nearest the linear reflective polarizer.
   Item 16. The recycling backlight system of item 14, wherein between the linear reflective polarizer and the quarter wave retarder, there is no layer having a retardance at 550 nm of more than 68 nm.
   Item 17. The recycling backlight system of item 1, wherein between the linear reflective polarizer and the quarter wave retarder, the total retardance for 550 nm light traveling a shortest path between the linear reflective polarizer and the quarter wave retarder is no more than 68 nm.

What is claimed is:

1. A recycling backlight system, comprising:
a circular reflective polarizer;
a reflector having a metallized reflective surface, the metallized reflective surface facing the circular reflective polarizer; and
a lightguide disposed between the reflector and the circular reflective polarizer.

2. The recycling backlight system of claim 1, wherein the circular reflective polarizer includes a linear reflective polarizer and a quarter wave retarder, wherein the quarter wave retarder is disposed nearer to the lightguide.

3. The recycling backlight system of claim 1, further comprising a liquid crystal module, wherein the liquid crystal module is disposed nearest the circular reflective polarizer.

4. The recycling backlight system of claim 1, wherein the reflector, the circular reflective polarizer, and the lightguide are bonded together to form a unitary body.

5. The recycling backlight system of claim 4, wherein the reflector, the circular reflective polarizer, and the lightguide are bonded by at least two different methods.

6. The recycling backlight system of claim 1, wherein the reflector is a structured reflector.

7. The recycling backlight system of claim 1, wherein between the circular reflective polarizer and the reflector, there is no layer having a retardance of more than 68 nm.

8. The recycling backlight system of claim 1, wherein between the circular reflective polarizer and the reflector, the total retardance for 550 nm light traveling a shortest path between the circular reflective polarizer and the reflector is no more than 68 nm.

9. A recycling backlight system, comprising:
a linear reflective polarizer;
a reflector having a metallized reflective surface, the metallized reflective surface facing the linear reflective polarizer;
a lightguide disposed between the reflector and the linear reflective polarizer; and
a quarter wave retarder disposed between the metallized reflective surface and the lightguide.

10. The recycling backlight system of claim 9 further comprising a liquid crystal module, wherein the liquid crystal module is disposed nearest the linear reflective polarizer.

11. The recycling backlight system of claim 9, wherein between the linear reflective polarizer and the quarter wave retarder, there is no layer having a retardance at 550 nm of more than 68 nm.

12. The recycling backlight system of claim 1, wherein between the linear reflective polarizer and the quarter wave retarder, the total retardance for 550 nm light traveling a shortest path between the linear reflective polarizer and the quarter wave retarder is no more than 68 nm.
